(19) United States
(12) Patent Application Publication
(10) Pub. No.: US 2005/0092621 A1
(43) Pub. Date: May 5, 2005

(54) Composite pad assembly for electrochemical mechanical processing (ECMP)

(76) Inventors: Yongqi Hu, San Jose, CA (US); Stan D. Tsai, Fremont, CA (US); Feng Q. Liu, San Jose, CA (US); Liang-Yuh Chen, Foster City, CA (US); Ralph Wadensweiler, Sunnyvale, CA (US); Paul D. Butterfield, San Jose, CA (US); Donald J.K. Olgado, Palo Alto, CA (US); Martin Wohlert, San Jose, CA (US); Sen-Hou Ko, Sunnyvale, CA (US); Shou-Sung Chang, Stanford, CA (US)

Correspondence Address: MOSER, PATTERSON & SHERIDAN, LLP/;APPLIED MATERIALS, INC., 3040 POST OAK BOULEVARD, SUTIE 1500, HOUSTON, TX, 77056, US

(21) Appl. No.: 10/980,888

(22) Filed: Nov. 3, 2004

Related U.S. Application Data
(63) Continuation-in-part of application No. 10/608,513, filed on Jun. 26, 2003.
(63) Continuation-in-part of application No. 10/140,010, filed on May 7, 2002.
(63) Continuation-in-part of application No. 10/211,626, filed on Aug. 2, 2002.
(63) Continuation-in-part of application No. 10/033,732, filed on Dec. 27, 2001.
(63) Continuation-in-part of application No. 09/505,899, filed on Feb. 17, 2000, now Pat. No. 6,537,144.
(63) Continuation-in-part of application No. 10/210,972, filed on Aug. 2, 2002.
(63) Continuation-in-part of application No. 10/151,538, filed on May 16, 2002, now abandoned.
(63) Continuation-in-part of application No. 10/244,697, filed on Sep. 16, 2002.
(63) Continuation-in-part of application No. 10/244,688, filed on Sep. 16, 2002, now Pat. No. 6,848,970.
(63) Continuation-in-part of application No. 10/391,324, filed on Mar. 18, 2003.
(63) Continuation-in-part of application No. 10/744,904, filed on Dec. 23, 2003.
(63) Continuation-in-part of application No. 10/642,128, filed on Aug. 15, 2003.
(63) Continuation-in-part of application No. 10/455,941, filed on Jun. 6, 2003.
(63) Continuation-in-part of application No. 10/455,895, filed on Jun. 6, 2003.
(60) Provisional application No. 60/516,680, filed on Nov. 3, 2003.

(51) Int. Cl. B23H 5/00

(52) U.S. Cl. 205/668

(57) ABSTRACT

Embodiments of a pad assembly for processing a substrate is provided herein. In one embodiment, the pad assembly includes a body that has a non-conductive first surface and an opposing second surface. A conductive element has a planar first surface laterally disposed from the non-conductive first surface and defines a top processing surface therewith. An electrode is coupled to the second surface of the body. A first set of holes is formed through the body and exposes the electrode to the processing surface.

### CROSS-REFERENCE TO RELATED APPLICATIONS

This application claims the benefit of U.S. Provisional Application No. 60/516,680 (Attorney Docket No. 4100L02), filed on Nov. 3, 2003. This application is also a continuation-in-part of U.S. patent application Ser. No. 10/744,904 (Attorney Docket No. 4100P10), filed Dec. 23, 2003 (hereinafter '904 application). The '904 application is a continuation-in-part of co-pending U.S. patent application Ser. No. 10/642,128 (Attorney Docket No. 4100P8), filed Aug. 15, 2003 (hereinafter the '128 application). The '128 application is a continuation-in-part of co-pending U.S. patent application Ser. No. 10/608,513 (Attorney Docket No. 4100P7), filed Jun. 26, 2003 (hereinafter referred to as the '513 application), which is a continuation-in-part of co-pending U.S. patent application No. 10/140,010 (Attorney Docket No. 7047), filed May 7, 2002. The '513 application is also a continuation-in-part of co-pending U.S. patent application Ser. No. 10/211,626 (Attorney Docket No. 4100P3), filed Aug. 2, 2002, which is a continuation-in-part of co-pending U.S. patent application Ser. No. 10/033,732 (Attorney Docket No. 4100P1, renumbered 4100Y2), filed Dec. 27, 2001, which is a continuation-in-part of U.S. patent application Ser. No. 09/505,899 (Attorney Docket No. 4100Y1), filed Feb. 17, 2000, now U.S. Pat. Ser. No. 6,537,144. The '513 application is additionally a continuation-in-part of co-pending U.S. patent application Ser. No. 10/210,972 (Attorney Docket No. 4100P2), filed Aug. 2, 2002, which is also a continuation-in-part of U.S. patent application Ser. No. 09/505,899 (Attorney Docket No. 4100Y1), filed Feb. 17, 2000, now U.S. Pat. Ser. No. 6,537,144. The '513 application is further a continuation-in-part of co-pending U.S. patent application Ser. No. 10/151,538 (Attorney Docket No. 6906), filed May 16, 2002. The '128 application is also a continuation-in-part of co-pending U.S. patent application Ser. No. 10/244,697 (Attorney Docket No. 6874), filed Sep. 16, 2002, which is a continuation-in-part of U.S. application Ser. No. 10/244,688 (Attorney Docket No. 7187), filed Sep. 16, 2002, and of co-pending U.S. patent application Ser. No. 10/391,324 (Attorney Docket No. 7661), filed Mar. 18, 2003. All of the above referenced applications are hereby incorporated by reference in their entireties.

This application is additionally a continuation in part of U.S. patent application Ser. No. 10/455,941 (Attorney Docket No. 4100P4), filed Jun. 6, 2003; and U.S. patent application Ser. No. 10/455,895 (Attorney Docket No. 4100P5), filed Jun. 6, 2003, all of which are also incorporated herein by reference in their entireties.

### BACKGROUND OF THE INVENTION

1. Field of the Invention

Embodiments of the invention generally relate to a pad assembly for electrochemical mechanical processing.

2. Description of the Related Art

Electrochemical Mechanical Processing (ECMP) is a technique used to deposit or remove conductive materials from a substrate surface. For example, in an ECMP polishing process, conductive materials are removed from the surface of a substrate by electrochemical dissolution while concurrently polishing the substrate with reduced mechanical abrasion as compared to conventional Chemical Mechanical Polishing (CMP) processes.

Electrochemical dissolution is performed by applying a bias between a cathode and a substrate surface to remove conductive materials from the substrate surface into a surrounding electrolyte. The bias may be applied to the substrate surface by a conductive contact disposed on or through a polishing material upon which the substrate is processed. A mechanical component of the polishing process is performed by providing relative motion between the substrate and the polishing material that enhances the removal of the conductive material from the substrate. ECMP systems may generally be adapted for deposition of conductive material on the substrate by reversing the polarity of the bias.

The energization, or biasing of the conductive material has been accomplished through the use of conductive balls that contact the conductive material during processing. However, although conductive balls as contact elements for biasing the conductive layer have demonstrated good results, service life and cost has made a search for an alternative contact element desirable.

Thus, there is a need for an improved apparatus for electrochemical mechanical polishing.

### SUMMARY OF THE INVENTION

In one embodiment, a pad assembly for processing a substrate is provided. The pad assembly includes a body that has a non-conductive first surface and an opposing second surface. A conductive element has a planar first surface laterally disposed from the non-conductive first surface and defines a top processing surface therewith. An electrode is coupled to the second surface of the body. A first set of holes is formed through the body and exposes the electrode to the processing surface. Optionally, an actuator may be provided for controlling the elevation of the first surface of the contact element relative to the non-conductive first surface, or to displace both first surfaces, jointly or independently. The actuator, by controlling the relative position of the first surface of the contact element and the non-conductive first surface, controls the relative pressure exerted by these surfaces against a substrate during processing.

In another embodiment, a processing pad assembly includes an upper layer having a processing surface. The processing surface has conductive and non-conductive regions formed therein. A first conductive layer is disposed beneath the upper layer and is in electrical contact with the conductive regions of the upper layer. A sub-layer is disposed beneath the first conductive layer and a second conductive layer is disposed beneath the sub-layer. A plurality of holes is formed through the non-conductive regions of the upper layer and extend through the first conductive layer and the sub-layer to at least an upper surface of the second conductive layer.

In another embodiment, a method of forming a processing pad assembly is provided. The method includes forming a plurality of holes through a non-conductive processing pad having a first surface and an opposing second surface. A first conductive layer is disposed on the second surface of the processing pad. The plurality of holes are then filled with a conductive material. In another embodiment, a sub-pad may be adhered to a bottom surface of the conductive layer and a plurality of holes formed through the non-conductive processing pad extending through the first conductive layer and the sub-pad. Optionally, a second conductive layer may be disposed on a bottom surface of the sub-pad.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side view, partially in cross-section, of one embodiment of an electrochemical mechanical processing station;

FIG. 2 is a partial sectional view of one embodiment of a pad assembly, contact element, and platen of the processing station of FIG. 1;

FIG. 3 is a plan view of one embodiment of an electrode of a pad assembly of the processing station of FIG. 1;

FIG. 4 is a plan view of another embodiment of an electrode of a pad assembly of the processing station of FIG. 1;

FIG. 5 is an isometric view of another embodiment of a pad assembly;

FIG. 6 is an isometric view of another embodiment of a pad assembly;

FIG. 7 is an isometric view of another embodiment of a pad assembly;

FIG. 8 is an isometric view of another embodiment of a pad assembly;

FIG. 9 is a partial sectional view of another embodiment of a contact element of the pad assembly;

FIG. 10 is a partial sectional view of another embodiment of a contact element of the pad assembly;

FIGS. 11A and 11B respectively depict partial sectional and top views of another embodiment of a pad assembly;

FIGS. 12A and 12B respectively depict partial sectional and top views of another embodiment of a pad assembly; and

FIG. 13 is a partial sectional view of another embodiment of a contact element of the pad assembly.

To facilitate understanding, identical reference numerals have been used, where possible, to designate identical elements that are common to the figures.

### DETAILED DESCRIPTION

Although the embodiments of the invention disclosed below focus primarily on polishing a substrate, it is contemplated that the teachings disclosed herein may be utilized to electroplate a substrate by reversing the polarity of the bias.

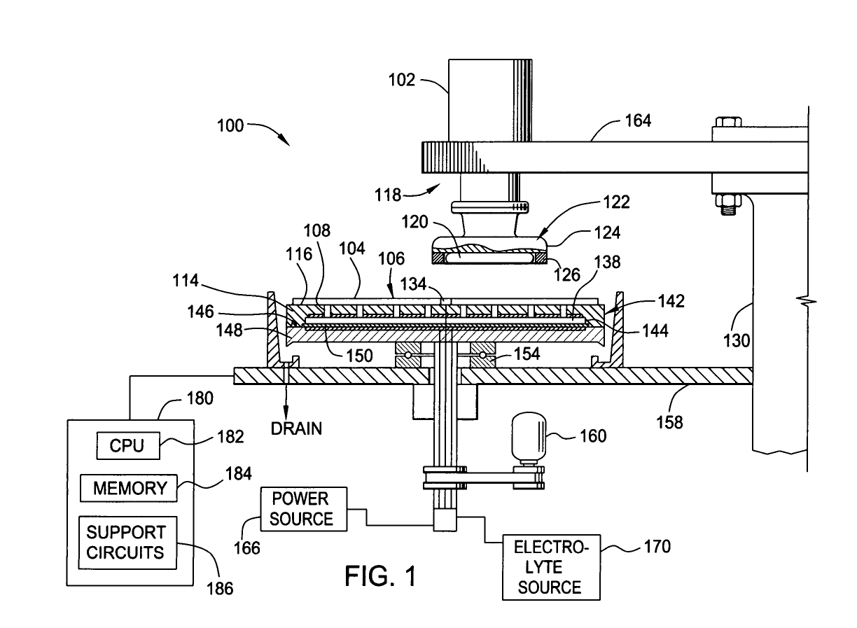

FIG. 1 depicts a sectional view of a processing station 100 having one embodiment of a pad assembly 106 of the present invention. The processing station 100 includes a carrier head assembly 118 adapted to hold a substrate 120 against a platen assembly 142. Relative motion is provided between the pad assembly 106 and the substrate 120 during processing. The relative motion may be rotational, linear, or some combination thereof and may be provided by at least one of the carrier head assembly 118 and the platen assembly 142.

In one embodiment, the carrier head assembly 118 may be positioned over the platen assembly 142 by an arm 164 coupled to a column 130. The carrier head assembly 118 generally includes a drive system 102 coupled to a carrier head 122. The drive system 102 generally provides at least rotational motion to the carrier head 122. The carrier head 122 additionally may be actuated toward the platen assembly 142 such that the substrate 120 retained in the carrier head 122 may be disposed against a processing surface 104 of the pad assembly 106 during processing.

In one embodiment, the carrier head 122 may be a TITAN HEAD™ or TITAN PROFILER™ wafer carrier manufactured by Applied Materials, Inc., of Santa Clara, Calif. Generally, the carrier head 122 comprises a housing 124 and retaining ring 126 that define a center recess in which the substrate 120 is retained while leaving a feature side of the substrate exposed. The retaining ring 126 circumscribes the substrate 120 disposed within the carrier head 122 to prevent the substrate 120 from slipping out from under the carrier head 122 during processing. It is contemplated that other carrier heads may be utilized.

The platen assembly 142 is rotationally disposed on a base 158. A bearing 154 is disposed between the platen assembly 142 and the base 158 to facilitate rotation of the platen assembly 142 relative to the base 158. A motor 160 is coupled to the platen assembly 142 to provide rotational motion.

In one embodiment, the platen assembly 142 includes an upper plate 114 and a lower plate 148. The upper plate 114 may be fabricated from a rigid material, such as a metal or rigid plastic, and in one embodiment, is fabricated from or coated with a dielectric material, such as chlorinated polyvinyl chloride (CPVC). The upper plate 114 may have a circular, rectangular or other geometric form with a planar top surface 116. A top surface 116 of the upper plate 114 supports the pad assembly 106 thereon. The pad assembly 106 may be held to the upper plate 114 of the platen assembly 142 by magnetic attraction, static attraction, vacuum, adhesives, or the like.

The lower plate 148 is generally fabricated from a rigid material, such as aluminum and may be coupled to the upper plate 114 by any conventional means, such as a plurality of fasteners (not shown). Generally, a plurality of locating pins 146 (one is shown in FIG. 1) are disposed between the upper and lower plates 114, 148 to ensure alignment therebetween. The upper plate 114 and the lower plate 148 may optionally be fabricated from a single, unitary member.

A plenum 138 is defined in the platen assembly 142 and may be partially formed in at least one of the upper or lower plates 114, 148. In the embodiment depicted in FIG. 1, the plenum 138 is defined in a recess 144 partially formed in the lower surface of the upper plate 114. At least one hole 108 is formed in the upper plate 114 to allow electrolyte, provided to the plenum 138 from an electrolyte source 170, to flow through the platen assembly 142 (and pad assembly 106 through passage 108 as described below) and into contact with the substrate 120 during processing. The plenum 138 is partially bounded by a cover 150 coupled to the upper plate 114 and enclosing the recess 144. Alternatively, the electrolyte may be dispensed from a pipe (not shown) onto the top surface of the pad assembly 106. It is contemplated that platen assemblies having other configurations may be utilized.

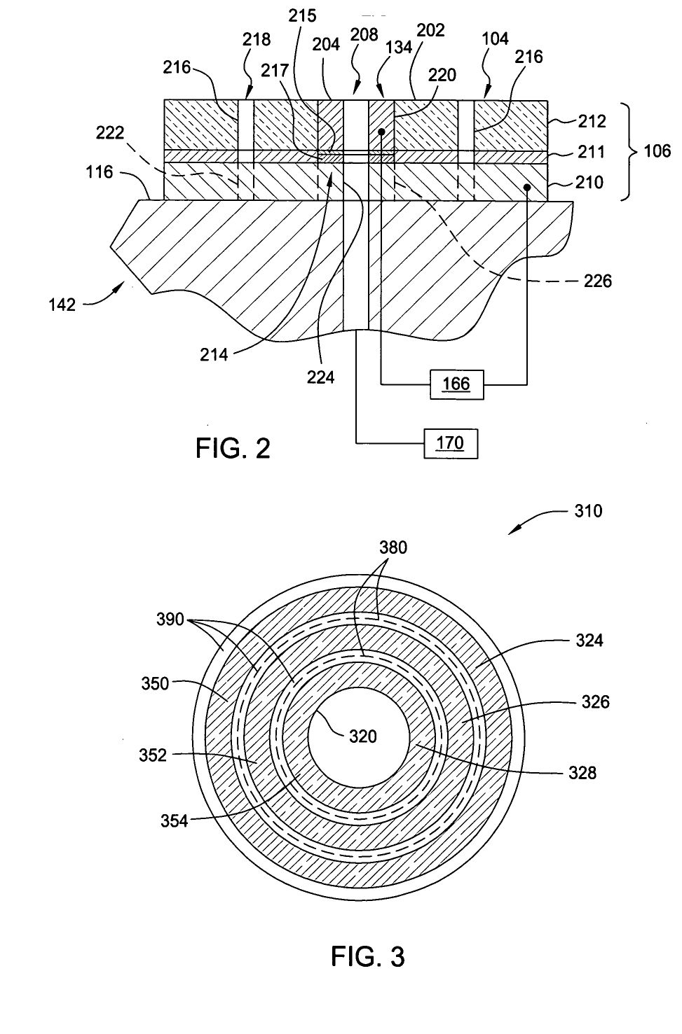

A pad assembly 106 and at least one contact element 134 are disposed on the platen assembly 142. The contact element 134 is adapted to electrically couple the substrate 120 to a power source 166. The contact element 134 may be coupled to the platen assembly 142, part of the pad assembly 106, or a separate element and is generally positioned to maintain contact with the substrate 120 during processing. The pad assembly 106 includes an electrode (210, shown in FIG. 2) coupled to a different terminal of the power source 166 such that an electrical potential may be established between the substrate 120 and the electrode 210 of the pad assembly 106. Electrolyte, which is introduced from the electrolyte source 170 and is disposed on the pad assembly 106, completes an electrical circuit between the substrate 120 and the electrode 210 as further discussed below, which assists in the removal of material from the surface of the substrate 120.

Alternatively, the pad assembly 106 may be configured without an electrode, in which case the electrode may be disposed upon or within the platen assembly 142. It is contemplated that multiple contact elements 134 and/or electrodes 210 may be used. The contact elements 134 and/or electrodes 210 may be independently biased.

To facilitate control of the processing station 100 as described above, a controller 180 is coupled to the processing station 100. The controller 180 is utilized to control power supplies, motors, drives, fluid supplies, valves, actuators, and other processing components of the processing station 100. The controller 180 comprises a central processing unit (CPU) 182, support circuits 186 and memory 184. The CPU 182 may be one of any form of computer processor that can be used in an industrial setting for controlling various chambers and sub-processors. The memory 184 is coupled to the CPU 182. The memory 184, or computer-readable medium, may be one or more of readily available memory such as random access memory (RAM), read only memory (ROM), floppy disk, hard disk, or any other form of digital storage, local or remote. The support circuits 186 are coupled to the CPU 182 for supporting the processor in a conventional manner. These circuits include cache, power supplies, clock circuits, input/output circuitry, subsystems, and the like.

The controller 180 may receive a metric indicative of processing performance for closed-loop process control of the processing station 100. For example, material removal in a polishing operation may be monitored by measuring and/or calculating the thickness of conductive material remaining on the substrate 120. The thickness of the material remaining on the substrate 120 may be measured and/or determined by, for example, optical measurement, interferometric end point, process voltage, process current, charge removed from the conductive material on the substrate, effluent component analysis, and other known means for detecting process attributes.

FIG. 2 depicts a partial sectional view of one embodiment of the pad assembly 106, contact element 134, and platen assembly 142 of FIG. 1. The pad assembly 106 includes at least a body, or upper layer 212 and a conductive lower layer, or electrode 210. In the embodiment depicted in FIG. 2, an optional subpad 211 is disposed between the electrode 210 and upper layer 212. The electrode 210, subpad 211, and upper layer 212 of the pad assembly 106, may be combined into a unitary assembly by the use of adhesives, such as a pressure sensitive adhesive, bonding, compression molding, or the like. As discussed above, the contact element 134 may be an integral part of the pad assembly 106, removably coupled thereto, or a separate component.

The processing surface 104 of the pad assembly 106 includes a non-conductive processing surface 202 and a conductive surface 204. In the embodiment depicted in FIG. 2, the conductive surface 204 is the upper surface of the contact element 134. The non-conductive processing surface 202 is part of the upper layer 212 and includes at least one permeable passage 218. Optionally, the at least one permeable passage 218 may also or alternatively be formed in the conductive surface 204.

The passage 218 extends through the non-conductive surface 202 at least to the electrode 210 and allows an electrolyte to establish a conductive path between the substrate 120 (shown in FIG. 1) and the electrode 210—i.e., the permeable passage 218 is disposed through all intervening layers such as, for example, the subpad 211. The passage 218 may be a permeable portion of the upper layer 212, holes formed in the upper layer 212, or a combination of the two. The subpad 211, when present, may also be formed of a permeable material or include holes which align with the passages 218 formed in the upper layer 212. In the embodiment depicted in FIG. 2, the permeable passage 218 is a plurality of holes 216 (only two shown for clarity) formed in and through the subpad 211 and upper layer 212 to allow electrolyte to flow therethrough and come into contact with the electrode 210 during processing.

Optionally, an extension 222 of the permeable passage 218 (shown in phantom) may be formed in and at least partially through the electrode 210. The extension 222 may extend completely through the electrode 210. The extension 222 increases the surface area of the electrode 210 in contact with the electrolyte which improves the rate of removal of material from the surface of the substrate 120 during processing. Electrolyte from the source 170 or other fluid may optionally flow through the holes 216.

The non-conductive surface 202, or optionally the entire upper layer 212, may be fabricated from polymeric materials compatible with process chemistry, examples of which include polyurethane, polycarbonate, nylon, acrylic polymers, epoxy, fluoropolymers, PTFE, PTFA, polyphenylene sulfide (PPS), or combinations thereof, and other polishing materials used in polishing substrate surfaces. In one embodiment, the non-conductive surface 202 of the pad assembly 106 is dielectric, for example, polyurethane or other polymer. In the embodiment depicted in FIG. 2, the non-conductive surface 202 and the upper layer 212 are the same material.

In one implementation, the upper layer 212 can be manufactured, e.g., by a molding process, with the permeable passages 218 formed in the upper layer 212. In one molding process, e.g., injection molding or compression molding, the pad material cures or sets in a mold that has indentations that form the holes 216 that form the permeable passage 218. Alternatively, the upper layer 212 can be manufactured by a more conventional technique, e.g., by skiving a thin sheet of pad material from a cast block. The permeable passages 218 may be part of a porous pad material. Alternatively, the permeable passages 218 may comprise holes 216 formed by machining the upper layer 212.

Examples of pad assemblies that may be adapted to benefit from the invention are described in U.S. patent application Ser. No. 10/455,941, filed Jun. 6, 2003 by Y. Hu et al. and U.S. patent application Ser. No. 10/455,895, filed Jun. 6, 2003 by Y. Hu et al., both previously incorporated by reference.

The subpad 211 is a compressible material that is softer and more compressible than the upper layer 212. For example, the subpad can be a closed-cell foam, such as polyurethane or polysilicone with voids, so that under pressure the cells collapse and the subpad compresses. In one embodiment, the subpad 211 comprises foamed urethane. Alternatively, the subpad 211 may be formed of other materials having other structures such as a mesh, cells, or solid configurations so longs as the compressibility of the subpad 211 meets the requirements detailed below. Examples of suitable subpad 211 materials include, but are not limited to, foamed polymers, elastomers, felt, impregnated felt, and plastics compatible with the polishing chemistries.

It is permissible for the material of the subpad 211 to be laterally displaced under pressure from the substrate. The subpad 211 can have a hardness in the range of from 2-90 on the Shore A scale. In one embodiment, the subpad 211 has a Shore A hardness in the range of from about 20 or less, such as 12 or less, or 5 or less.

In addition, the subpad 211 has a thickness of, e.g., 30 mils or more. In one embodiment, the subpad 211 has a thickness of 90 mils or more. For example, the subpad may be about 95 to 500 mils thick, such as 95 to 200 mils, or 95 to 150 mils, or 95 to 125 mils.

In general, the thickness of the subpad 211 is selected to ensure that, given the compressibility of the subpad 211 and the rigidity of the upper layer 212, the upper layer will deflect at very low pressures, e.g., pressures of 0.5 psi or less, an amount at least equal to any non-uniformity in the thickness of the upper layer, e.g., about 2 mil. Compressibility may be measured as a percentage thickness change at a given pressure. For example, under a pressure of about 0.5 psi, the subpad 211 can undergo about 3% compression. For Example, a 100 mil thick subpad should have a compression of at least 2% at 0.5 psi, whereas a 200 mil thick subpad should have a compression of at least 1% at 0.5 psi. A suitable material for the subpad is PORON 4701-30 from Rogers Corporation, in Rogers, Conn. (PORON is a trademark of Rogers Corporation).

Moreover, the subpad should be sufficiently compressible that at the operating pressures of interest, e.g., at 1 psi or less, the polishing pad assembly is below the maximum compressibility of the polishing pad assembly. The subpad can have a maximum compressibility greater than about 10%, or greater than about 20%. In one implementation, the subpad can have a compressibility of about 25% at pressures of about 1 to about 9 psi at a 0.2 in/min strain rate, with a maximum compressibility that is even higher.

In brief, at pressures of 1 psi or below (and possibly at 0.8 psi or below, or 0.5 psi or below, or 0.3 psi or below), the subpad can have a product of the compressibility and thickness (C·D) that is greater than the non-uniformities in thickness of the cover layer. For example, at pressures of 0.8 psi or below (and possibly at 0.5 psi or below), the subpad can have a product of the compressibility and thickness (C·D) of 2 mils or more (and possibly 3 mils or more).

Hydrostatic modulus K may be measured as applied pressure (P) divided volumetric strain (ΔV/V), i.e., K=PV/ΔV. Assuming that the subpad undergoes pure compression (i.e., material is not displaced laterally under the applied pressure), then the hydrostatic modulus K equals the applied pressure divided by the compression (ΔD/D). Thus, assuming that the subpad undergoes at least 2% pure compression at 0.5 psi, the subpad would have a compressibility modulus K of 25 or less. On the other hand, if even lower pressures are to be used, e.g., pressures of 0.1 psi, then the subpad 211 should have a compressibility modulus of 5 or less. The subpad may have a compressibility modulus K of 50 psi or less per psi of applied pressure in the range of 0.1 to 1.0 psi. Of course, if the material of the subpad does undergo lateral displacement under compression, then the volumetric strain will be somewhat less than the compression, so the hydrostatic modulus may be somewhat higher.

Without being limited to any particular theory, this configuration permits the downward force from the substrate to “flatten out” the non-conductive surface 202 of the upper layer 212 at low pressures, even at pressures of 0.5 psi or less, such as 0.3 psi or less, such as 0.1 psi, and thus substantially compensate for the thickness non-uniformity of the upper layer. For example, the variations in thickness of the upper layer 212 are absorbed by the compression of the subpad 211, so that the processing surface remains in substantially uniform contact with the substantially planar substrate across the substrate surface. As a result, a uniform pressure can be applied to the substrate by the processing pad, thereby improving processing uniformity during low pressure processing. Consequently, materials that require low-pressure processing to avoid delamination, such as low-k dielectric materials, can be processed with an acceptable degree of uniformity. It is contemplated that the embodiments of the subpad 211 disclosed above is applicable to any embodiment of processing pad assemblies disclosed herein that have subpads.

The electrode 210 is disposed on the top surface 116 of the platen assembly 142 and may be held there by magnetic attraction, static attraction, vacuum, adhesives, or the like. In one embodiment, adhesive is used to secure the electrode 210 to the upper plate 114. It is contemplated that other layers, such as release films, liners, and/or other adhesive layers, may be disposed between the electrode 210 and the top surface 116 to facilitate ease of handling, insertion, and removal of the pad assembly 106 from the platen assembly 142.

The electrode 210 is coupled to the power source 166 and may act as a single electrode, or may comprise multiple independently biasable electrode zones isolated from each other. The electrode 210 is typically comprised of a corrosion resistant conductive material, such as metals, conductive alloys, metal coated fabrics, conductive polymers, conductive pads, and the like. Conductive metals include Sn, Ni, Cu, Au, and the like. Conductive metals also include a corrosion resistant metal such as Sn, Ni, or Au coated over an active metal such as Cu, Zn, Al, and the like. Conductive alloys include inorganic alloys and metal alloys such as bronze, brass, stainless steel, or palladium-tin alloys, among others. Metal coated fabric may be woven or non-woven with any corrosion resistant metal coating. Conductive pads may consist of conductive fillers disposed in a polymer matrix. The electrode 210 should also be fabricated of a material compatible with electrolyte chemistries to minimize cross-talk between zones when multi-zoned electrodes are utilized. For example, metals stable in the electrolyte chemistries are able to minimize zone cross-talk.

When metal is used as the material for the electrode 210, it may be a solid sheet. Alternatively, the electrode 210 may be perforated or formed of a metal screen in order to increase the adhesion to the upper layer 212 or the optional subpad 211. The electrode 210 may also be primed with an adhesion promoter to increase the adhesion to the upper layer 212 or the optional subpad 211. An electrode 210 which is perforated or formed of a metal screen also has a greater surface area which further increases the substrate removal rate during processing.

When the electrode 210 is fabricated from metal screen, a perforated metal sheet, or conductive fabric, one side of the electrode 210 may be laminated, coated, or molded with a polymer layer which penetrates the openings in the electrode 210 to further increase adhesion to the upper layer 212 or the optional subpad 211. When the electrode 210 is formed from a conductive pad, the polymer matrix of the conductive pad may have a high affinity or interaction to an adhesive applied to the upper layer 212 or the optional subpad.

The contact element 134 may be integrally or removably coupled to the upper layer 212, the electrode 210, the upper surface 116 of the platen assembly 142, or combinations thereof. In one embodiment, at least one aperture 220 is formed in at least the upper layer 212 and the optional subpad 211 of the pad assembly 106. Alternatively, the at least one aperture 220 may extend completely through the pad assembly 106, as shown in phantom at 226 in FIG. 2. Each of the apertures 220 is of a size and location to accommodate a contact element 134 disposed therethrough. In one embodiment, the at least one aperture 220 is a single aperture formed in the center of the subpad 211 and the upper layer 212 to accommodate a single contact element 134, such that the contact element 134 and the upper layer 212 are concentric. In another embodiment, a plurality of apertures 220 may be formed through the subpad 211 and the upper layer 212, or through the subpad 211, the upper layer 212, and the electrode 210 to accommodate a plurality of contact elements 134. For example, FIG. 5 depicts a pad assembly 506 having four spaced contact elements 134 disposed in four apertures 220 formed in the upper layer 212.

It is contemplated that any number of contact elements 134 may be utilized in any geometric configuration across the pad assembly 106. The contact elements 134 may be disposed in any location or combination of locations on the pad assembly 106, for example, at the center, the edge, the middle, or combinations thereof. It is also contemplated that contact elements 134 may be formed in any geometric shape including, but not limited to, circles, ellipses, polygons, arcs, spirals, wavy lines, line segments, radii, and the like. For example, a centrally disposed contact element 134, as depicted in FIG. 2, could be used in conjunction with one or more other contact elements 134, such as depicted in any of FIGS. 5-8, described below.

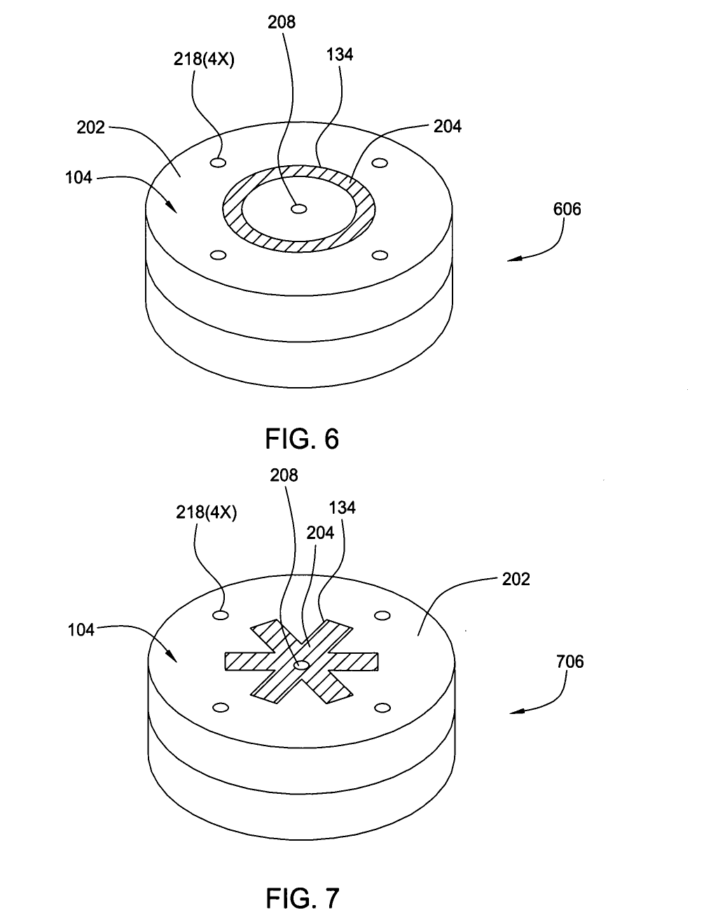

For example, FIG. 6 depicts a pad assembly 606 including a contact element 134 having an annular shape that separates the non-conductive processing surface 202 into at least two portions. Alternatively, multiple concentric rings (not shown) could be used to separate the non-conductive processing surface 202 into a number of desired portions. FIG. 7 depicts a pad assembly 706 including a contact element 134 having an asterisk, or star, shape.

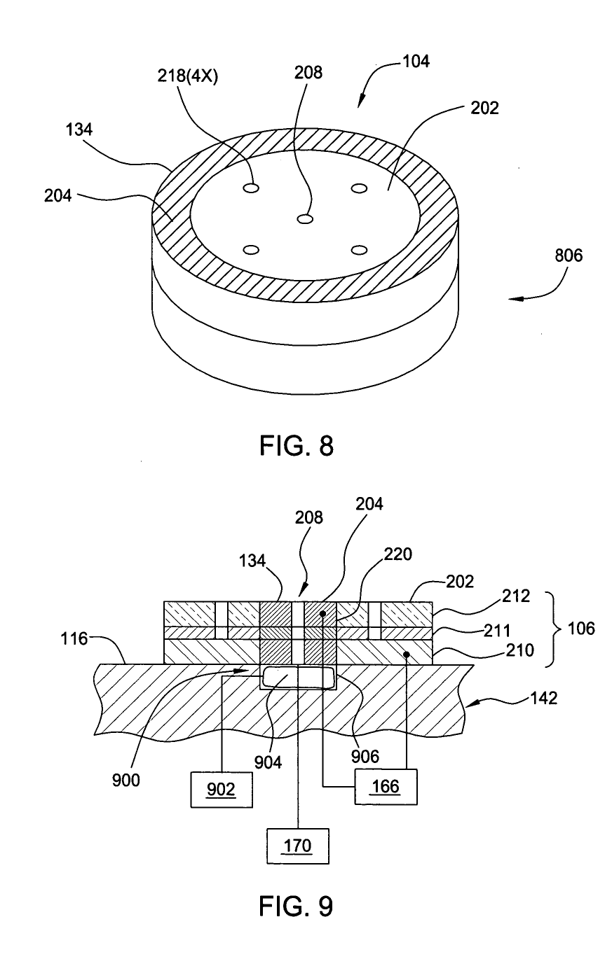

In another embodiment, the contact element 134 circumscribes at least a portion of the non-conductive processing surface 202, rather than being disposed in an aperture 220. For example, FIG. 8 depicts a pad assembly 806 having a contact element 134 that has an annular shape and circumscribes the non-conductive processing surface 202. The embodiments depicted herein are illustrative only and other configurations are contemplated. Note that any of the embodiments of contact elements 134 depicted in any of FIGS. 2, and 5-8, above, or other geometries not specifically shown in the drawings, may be used alone or in combination with each other. Note that the conductive surfaces depicted in FIGS. 5-8 are cross-hatched solely for clarity and illustrative purposes.

Returning to the embodiment depicted in FIG. 2, at least one permeable passage 208 is disposed through the pad assembly 106 in fluid communication with the electrolyte source 170 through the platen assembly 142. The permeable passage 208 may be a permeable portion of the contact element 134, holes formed in the contact element 134, or a combination thereof.

The permeable passage 208 allows electrolyte to establish a conductive path for improving removal rate and facilitates cooling down the conductive surface 204, which may have increased temperature due to friction and the high current flowing through the conductive surface 204 during polishing, thereby enhancing process repeatability and extending service life. In addition, the passage 208 formed in the conductive surface 204 allows the electrolyte to be delivered from the bottom of the pad assembly 106. Optionally, an insulator (not shown) may be provided on at least a portion of an inner wall 224 of the passage 108 to prevent current from flowing directly between the contact element 134 and the electrode 210 through the passage 208. Alternatively, the electrolyte may be delivered from a fluid delivery tube (not shown) disposed above the pad assembly 106 without the need for the permeable passage 208.

In the embodiment depicted in FIG. 2, the permeable passage 208 is formed through the center of the contact element 134. Although one centrally located passage 208 is shown in FIG. 2, a plurality of passages 208 may be disposed through the contact element 134. Alternatively or in addition, a plurality of holes for electrolyte delivery may be formed in other portions of the pad assembly 106, such as through the non-conductive surface 202.

The contact element 134 is coupled to the power source 166 and has a conductive processing surface 204 that defines a second portion of the processing surface 104. In one embodiment, the conductive processing surface 204 is planar. The planar conductive processing surface 204 may be embossed or textured.

The conductive processing surface 204 of the contact element 134 may be disposed at a height substantially co-planar with the non-conductive processing surface 202 of the pad assembly 106. Alternatively, the conductive surface 204 may be slightly higher or lower than the non-conductive surface 202 such that when one of the surfaces 202, 204 is compressed under processing conditions, desired electrical contact is maintained between the substrate 120 and the conductive surface 204 and mechanical contact is maintained between the non-conductive surface 202 and the substrate 120.

The contact element 134 is electrically separated from electrode 210. In the embodiment depicted in FIG. 2, the contact element 134 is disposed on a dielectric subpad 214 disposed on the electrode 210. The subpad 214 may include a harder upper layer 215 disposed next to the contact element 134 and a softer lower layer 217. The lower layer 217 may be disposed on the subpad 211 or electrode 210 (as shown in FIG. 2), or in embodiments where a portion of the passage 220 extends beyond the electrode 210 (as shown in phantom in FIG. 2), the lower layer 217 may be disposed on the upper surface 116 of the platen assembly 142. In one embodiment, the lower layer 217 is softer than the subpad 211.

In one embodiment, the contact element 134 has a circular shape with a diameter ranging from 2 to 16 inches. The edge of the conductive surface 204 of the contact element 134 may be relieved or may be manufactured or assembled to recess to avoid the possibility of defects introduced by scratching the contact element 134 against the surface of the substrate 120.

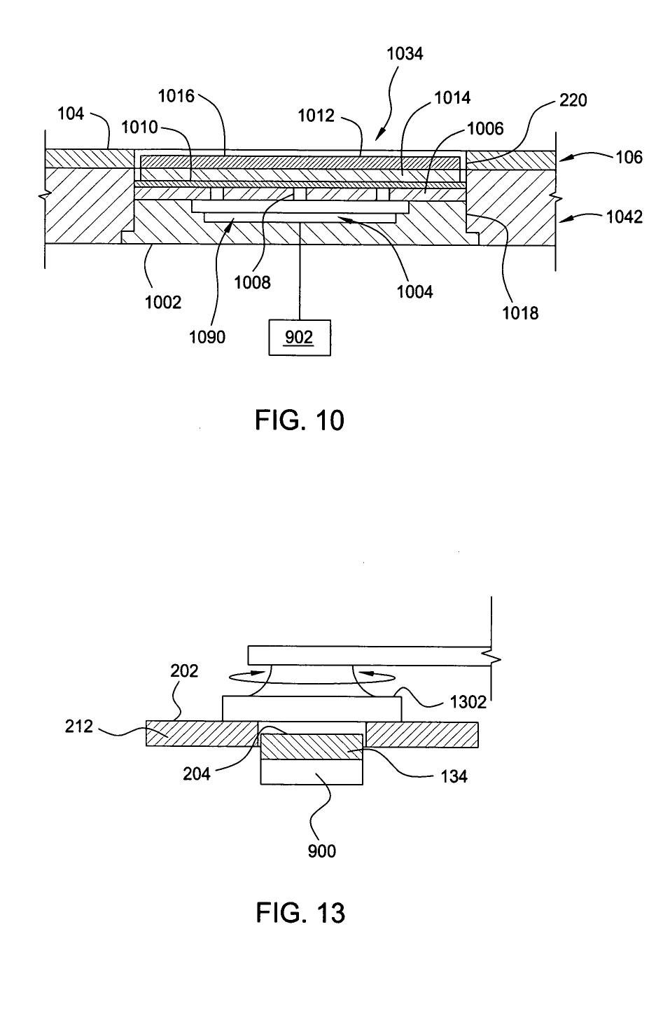

In one embodiment, the conductive surface 204 of the contact element 134 extends beyond the non-conductive surface 202. During polishing, conductive surface 204 is urged substantially coplanar with the non-conductive surface 202 through either the compression of subpad 214 or through adjusting the relative position of the non-conductive surface 202 and contact element 134 as discussed below with respect to FIGS. 9-10.

The contact element 134 described herein may be formed from conductive materials that may comprise a conductive polishing material or may comprise a conductive element disposed in a dielectric or conductive polishing material. In one embodiment, a conductive polishing material may include conductive fibers, conductive fillers, or combinations thereof. The conductive fibers, conductive fillers, or combinations thereof may be dispersed in a binder comprising polymeric material.

The conductive fibers may comprise conductive or dielectric materials, such as dielectric or conductive polymers or carbon-based materials, at least partially coated or covered with a conductive material including a metal, a carbon-based material, a conductive ceramic material, a conductive alloy, or combinations thereof. The conductive fibers may be in the form of fibers or filaments, a conductive fabric or cloth, one or more loops, coils, or rings of conductive fibers. Multiple layers of conductive materials, for example, multiple layers of conductive cloth or fabric, may be used to form the conductive polishing material.

The conductive fibers include dielectric or conductive fiber materials coated with a conductive material. Dielectric polymeric materials may be used as fiber materials. Examples of suitable dielectric fiber materials include polymeric materials, such as polyamides, polyimides, nylon polymer, polyurethane, polyester, polypropylene, polyethylene, polystyrene, polycarbonate, diene containing polymers, such as AES (polyacrylontrile ethylene styrene), acrylic polymers, or combinations thereof. The invention also contemplates the use of organic or inorganic materials that may be used as the fibers described herein.

The conductive fiber material may comprise intrinsically conductive polymeric materials including polyacetylene, polyethylenedioxythiophene (PEDT), which is commercially available under the trade name Baytron™, polyaniline, polypyrrole, polythiophene, carbon-based fibers, or combinations thereof. Another example of a conductive polymer is polymer-noble metal hybrid materials. Suitable polymer-noble metal hybrid materials are generally chemically inert to a surrounding electrolyte and include, for example, hybrids containing noble metals that are resistant to oxidation. An example of a polymer-noble metal hybrid material is a platinum-polymer hybrid material. Examples of conductive polishing materials, including conductive fibers, are more fully described in co-pending U.S. patent application Ser. No. 10/033,732, filed on Dec. 27, 2001, previously incorporated herein by reference in its entirety. The invention also contemplates the use of organic or inorganic materials that may be used as fibers described herein.

The fiber material may be solid or hollow in nature. The fiber length may be in the range between about 1 μm and about 1000 mm with a diameter between about 0.1 μm and about 1 mm. In one aspect, the diameter of fiber may be between about 5 μm to about 200 μm with an aspect ratio of length to diameter of about 5 or greater, such as about 10 or greater, for conductive polymer composites and foams, such as conductive fibers disposed in polyurethane. The cross-sectional area of the fiber may be circular, elliptical, star-patterned, “snow flaked”, or of any other shape of manufactured dielectric or conductive fibers. High aspect ratio fibers having a length between about 5 mm and about 1000 mm and a diameter of between about 5 μm and about 1000 μm may be used for forming meshes, loops, fabrics or cloths, of the conductive fibers. The fibers may also have an elasticity modulus in the range between about 10⁴ psi and about 10⁸ psi. However, the invention contemplates any elastic modulus necessary to provide for compliant, elastic fibers in the polishing articles and processes described herein.

Conductive material disposed on the conductive or dielectric fiber material generally include conductive inorganic compounds, such as a metal, a metal alloy, a carbon-based material, a conductive ceramic material, a metal inorganic compound, or combinations thereof. Examples of metal that may be used for the conductive material coatings herein include noble metals, tin, lead, copper, nickel, cobalt, and combinations thereof. Noble metals include gold, platinum, palladium, iridium, rhenium, rhodium, rhenium, ruthenium, osmium, and combinations thereof, of which gold and platinum are preferred. The invention also contemplates the use of other metals for the conductive material coatings than those illustrated herein. Carbon-based material includes carbon black, graphite, and carbon particles capable of being affixed to the fiber surface. Examples of ceramic materials include niobium carbide (NbC), zirconium carbide (ZrC), tantalum carbide (TaC), titanium carbide (TiC), tungsten carbide (WC), and combinations thereof. The invention also contemplates the use of other metals, other carbon-based materials, and other ceramic materials for the conductive material coatings than those illustrated herein. Metal inorganic compounds include, for example, copper sulfide or danjenite, Cu_{g}S₅, disposed on polymeric fibers, such as acrylic or nylon fibers. The danjenite coated fibers are commercially available under the tradename Thunderon® from Nihon Sanmo Dyeing Co., Ltd, of Japan. The Thunderon® fibers typically have a coating of danjenite, Cu_{g}S₅, between about 0.03 μm and about 0.1 μm and have been observed to have conductivities of about 40 Ω/cm. The conductive coating may be disposed directly on the fiber by plating, coating, physical vapor deposition, chemical deposition, binding, or bonding of the conductive materials. Additionally, a nucleation, or seed, layer of a conductive material, for example, copper, cobalt or nickel, may be used to improve adhesion between the conductive material and the fiber material. The conductive material may be disposed on individual dielectric or conductive fibers of variable lengths as well as on shaped loops, foams, and cloths or fabrics made out of the dielectric or conductive fiber material.

An example of a suitable conductive fiber is a polyethylene fiber coated with gold. Additional examples of the conductive fibers include acrylic fibers plated with gold and nylon fibers coated with rhodium. An example of a conductive fiber using a nucleation material is a nylon fiber coated with a copper seed layer and a gold layer disposed on the copper layer.

The conductive fillers may include carbon based materials or conductive particles and fibers. Particle sizes of conductive fillers may range between about 0.1 to about 500 μm. Examples of conductive carbon-based materials include carbon powder, carbon fibers, carbon nanotubes, carbon nanofoam, carbon aerogels, graphite, and combinations thereof. Examples of conductive particles or fibers include intrinsically conductive polymers, dielectric or conductive particles coated with a conductive material, dielectric filler materials coated in conductive materials, conductive inorganic particles including metal particles such as gold, platinum, tin, copper, nickel, lead and other metal or metal alloy particles, conductive ceramic particles, and combinations thereof. The conductive fillers may be partially or completely coated with a metal, such as a noble metal, a carbon-based material, conductive ceramic material, a metal inorganic compound, or combinations thereof, as described herein. An example of a filler material is a carbon fiber or graphite coated with copper or nickel. Conductive fillers may be spherical, elliptical, longitudinal with certain aspect ratio, such as 2 or greater, or of any other shape of manufactured fillers. Filler materials are broadly defined herein as materials that may be disposed in a second material to alter, the physical, chemical, or electrical properties of the second material. As such, filler materials may also include dielectric or conductive fiber material partially or completely coated in a conductive metal or conductive polymers as described herein. The fillers of dielectric or conductive fiber material partially or completely coated in a conductive metal or conductive polymers may also be complete fibers or pieces of fibers.

The conductive materials are used to coat both dielectric and conductive fibers and fillers to provide a desired level of conductivity for forming the conductive polishing material. Generally, the coating of conductive material is deposited on the fiber and/or filler material to a thickness between about 0.01 μm and about 50 μm, such as between about 0.02 μm and about 10 μm. The coating typically results in fibers or fillers having resistivities less than about 100 Ω-cm, such as between about 0.001 Ω-cm and about 32 Ω-cm. The invention contemplates that resistivities are dependent on the materials of both the fiber or filler and the coating used, and may exhibit resistivities of the conductive material coating, for example, platinum, which has a resistivity 9.81 Ω-cm at 0° C. An example of a suitable conductive fiber includes a nylon fiber coated with about 0.1 μm copper, nickel, or cobalt, and about 2 μm of gold disposed on the copper, nickel, or cobalt layer, with a total diameter of the fiber between about 30 μm and about 90 μm.

The conductive polishing material may include a combination of the conductive or dielectric fibers material at least partially coated or covered with an additional conductive material and conductive fillers for achieving a desired electrical conductivity or other polishing article properties. An example of a combination is the used of gold coated nylon fibers and graphite as the conductive material comprising at least a portion of a conductive polishing material.

The conductive fiber material, the conductive filler material, or combinations thereof, may be dispersed in a binder material or form a composite conductive polishing material. One form of binder material is a conventional polishing material. Conventional polishing materials are generally dielectric materials such as dielectric polymeric materials. Examples of dielectric polymeric polishing materials include polyurethane and polyurethane mixed with fillers, polycarbonate, polyphenylene sulfide (PPS), Teflon™ polymers, polystyrene, ethylene-propylene-diene-methylene (EPDM), or combinations thereof, and other polishing materials used in polishing substrate surfaces. The conventional polishing material may also include felt fibers impregnated in urethane or be in a foamed state. The invention contemplates that any conventional polishing material may be used as a binder material (also known as a matrix) with the conductive fibers and fillers described herein.

Additives may be added to the binder material to assist the dispersion of conductive fibers, conductive fillers or combinations thereof, in the polymer materials. Additives may be used to improve the mechanical, thermal, and electrical properties of the polishing material formed from the fibers and/or fillers and the binder material. Additives include cross-linkers for improving polymer cross-linking and dispersants for dispersing conductive fibers or conductive fillers more uniformly in the binder material. Examples of cross-linkers include amino compounds, silane crosslinkers, polyisocyanate compounds, and combinations thereof. Examples of dispersants include N-substituted long-chain alkenyl succinimides, amine salts of high-molecular-weight organic acids, co-polymers of methacrylic or acrylic acid derivatives containing polar groups such as amines, amides, imines, imides, hydroxyl, ether, Ethylene-propylene copolymers containing polar groups such as amines, amides, imines, imides, hydroxyl, ether. In addition sulfur containing compounds, such as thioglycolic acid and related esters have been observed as effective dispersers for gold coated fibers and fillers in binder materials. The invention contemplates that the amount and types of additives will vary for the fiber or filler material as well as the binder material used, and the above examples are illustrative and should not be construed or interpreted as limiting the scope of the invention.

Further, a mesh of the conductive fiber and/or filler material may be formed in the binder material by providing sufficient amounts of conductive fiber and/or conductive filler material to form a physically continuous or electrically continuous medium or phase in the binder material. The conductive fibers and/or conductive fillers generally comprise between about 2 wt. % and about 85 wt. %, such as between about 5 wt. % and about 60 wt. %, of the polishing material when combined with a polymeric binder material.

The contact element 134 may include an interwoven fabric or cloth of the fiber material coated with a conductive material. Optionally, a conductive filler may be disposed in a binder impregnated into the fabric or cloth. The fiber material coated with a conductive material may be interwoven to form a yarn. The yarns may be brought together to make a conductive mesh with the help of adhesives or coatings. The yarn may be disposed as a conductive element in a polishing pad material or may be woven into a cloth or fabric.

Alternatively, the conductive fibers and/or fillers may be combined with a bonding agent to form a composite conductive polishing material. Examples of suitable bonding agents include epoxies, silicones, urethanes, polyimides, a polyamide, a fluoropolymer, fluorinated derivatives thereof, or combinations thereof. Additional conductive material, such as conductive polymers, additional conductive fillers, or combinations thereof, may be used with the bonding agent for achieving desired electrical conductivity or other polishing article properties. The conductive fibers and/or fillers may include between about 2 wt. % and about 85 wt. %, such as between about 5 wt. % and about 60 wt. %, of the composite conductive polishing material.

The conductive fiber and/or filler material may be used to form conductive polishing materials or articles having bulk or surface resistivity of about 50 Ω-cm or less, such as a resistivity of about 3 Ω-cm or less. In one aspect of the polishing article, the polishing article or polishing surface of the polishing article has a resistivity of about 1 Ω-cm or less. Generally, the conductive polishing material or the composite of the conductive polishing material and conventional polishing material are provided to produce a conductive polishing article having a bulk resistivity or a bulk surface resistivity of about 50 Ω-cm or less. An example of a composite of the conductive polishing material and conventional polishing material includes gold or carbon coated fibers which exhibit resistivities of 1 Ω-cm or less, disposed in a conventional polishing material of polyurethane in sufficient amounts to provide a polishing article having a bulk resistivity of about 10 Ω-cm or less.

The contact element 134 formed from the conductive fibers and/or fillers described herein generally have mechanical properties that do not degrade under sustained electric fields and are resistant to degradation in acidic or basic electrolytes. The conductive material and any binder material used are combined to have equivalent mechanical properties, if applicable, of conventional polishing materials used in a conventional polishing article. For example, the conductive polishing material, either alone or in combination with a binder material, has a hardness of about 100 or less on the Shore D Hardness scale for polymeric materials as described by the American Society for Testing and Materials (ASTM), headquartered in Philadelphia, Pa. In one aspect, the conductive material has a hardness of about 80 or less on the Shore D Hardness scale for polymeric materials. The conductive polishing portion 310 generally includes a surface roughness of about 500 microns or less. The properties of the polishing pad are generally designed to reduce or minimize scratching of the substrate surfaces during mechanical polishing and when applying a bias to the substrate surface.

Examples of conductive materials and structures suitable for use as contact elements 134 are described in U.S. patent application Ser. No. 10/455,941, filed Jun. 6, 2003 by Y. Hu et al. and U.S. patent application Ser. No. 10/455,895, filed Jun. 6, 2003 by Y. Hu et al., both previously incorporated by reference in their entireties. In one embodiment, the conductive layer consists of tin particles disposed in a polymer matrix. In another embodiment, the conductive layer consists of nickel and/or copper particles disposed in a polymer matrix. The mixture of particles in the polymer matrix may be disposed over a dielectric fabric coated with metal, such as copper, tin, or gold, and the like.

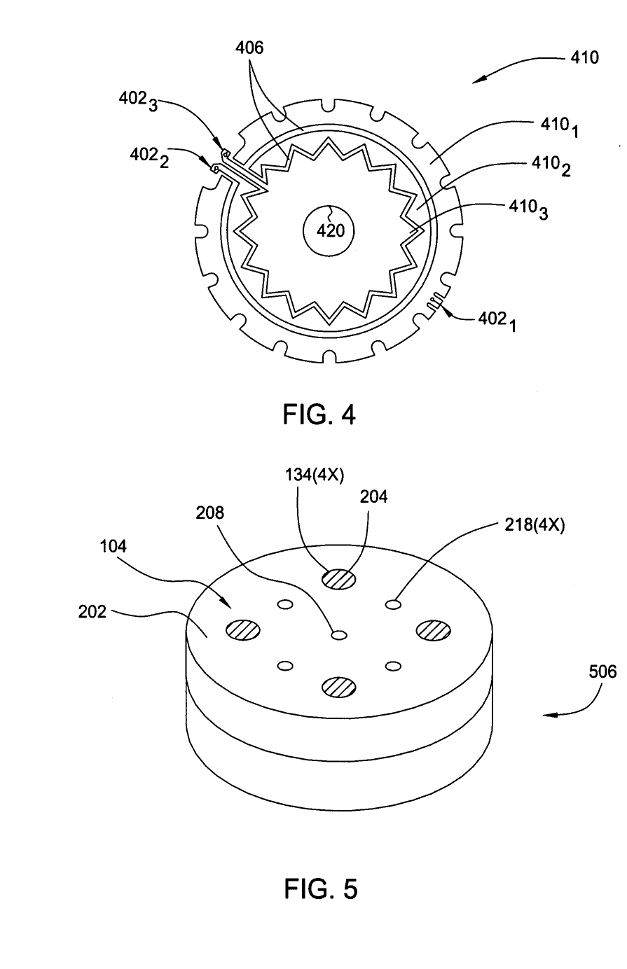

FIGS. 3 and 4 show bottom views of alternative embodiments of electrodes having multiple zones that may be advantageously adapted for use with the various embodiments of the invention described herein. In FIG. 3, the electrode 310 includes at least one dielectric spacer and at least two conductive elements. The conductive elements are arranged to create a plurality of independently biasable zones across the surface of the electrode 310. In the embodiment depicted in FIG. 3, the electrode 310 has at three conductive elements 350, 352, 354 that are electrically isolated from each other by dielectric spacers 390 to create electrode zones, an outer electrode zone 324, an intermediate electrode zone 326, and an inner electrode zone 328. Each electrode zone 324, 326, 328—shown separated by a dashed boundary 380—may be independently biased to allow the substrate polishing profile to be tailored. One example of a polishing method having electrode zone bias control is described in U.S. patent application Ser. No. 10/244,697, filed Sep. 16, 2002, which has been previously incorporated by reference in its entirety.

Although the electrode zones 324, 326, 328 and conductive elements 350, 352, 354 are shown as concentric rings, the electrode zones may be alternatively configured to suit a particular polishing application. For example, the electrode zones 324, 326, 328 and/or conductive elements 350, 352, 354 may be linear, curved, concentric, involute curves or other shapes and orientations. The electrode zones 324, 326, 328 and/or conductive elements 350, 352, 354 may be of substantially equal size and shape from one zone to the next, or the sizes and shapes may vary depending upon the particular zone of concern.

It is further contemplated that the electrode zones may be created and positioned in any arrangement with respect to the processing surface 104 of the pad assembly 106 to more finely control processing of the substrate 120. The electrode zones may also be grouped into sets. For example, one set of electrode zones may be created to correspond with the non-conductive processing surface 202 of the pad assembly 106, while a second set of electrode zones may be created to correspond with the conductive surface 204 of the pad assembly 106. In embodiments where multiple regions of conductive and nonconductive processing surfaces exist, multiple sets of zones may be created to coincide with each respective region. Alternatively, the zones may be defined partially or wholly irrespectively of the conductive and non-conductive processing surfaces of the pad assembly 106.

FIG. 4 depicts another embodiment of an electrode 410 having a plurality of independently biasable electrode zones. In one embodiment, the electrode 410 has at least n zone electrodes (shown as three electrodes 410₁, 410₂, and 410₃), wherein n is an integer of 2 or greater. The electrodes 410₁, 410₂, and 410₃ each include a respective terminal 402₁, 402₂, 402₃ for coupling to a power source. The electrodes 410₁, 410₂, and 410₃ are generally separated by a dielectric spacer 406 or an air gap and each form an independent electrode zone. The electrodes 410₁, 410₂, and 410₃ may include one or more apertures 420 to facilitate interfacing with one or more conductive elements, such as the contact elements 134 depicted in FIGS. 1 and 2.

In any of the embodiments described above, the contact element 134 may optionally further comprise an actuator adapted to control the position and/or pressure exerted between the conductive surface 204 of the contact element 134 and the substrate 120. FIG. 9 depicts one embodiment of a contact pressure controller 900. In one embodiment, the contact pressure controller 900 includes an inflatable membrane 904 disposed below the contact element 134. The inflatable membrane 904 is coupled to a fluid supply 902, such as a compressed air line. Appropriate valves (not shown) are provided to allow the inflatable membrane 904 to be controllably inflated or deflated as desired either manually or via the controller 180. The membrane 904 may be made of ethylene propylene diene monomer (EPDM) or other suitable materials. The inflatable membrane 904 presses against the bottom of the contact element 134 to selectively raise or lower the conductive surface 204 of the contact element 134 relative to the non-conductive surface 202 of the upper layer 212.

Thus, by controlling the fluid pressure applied to the inflatable membrane 904, the force exerted by the contact element 134 against the substrate 120 can be controlled during processing. As discussed above with respect to general control of the processing station 100, the controller 180 may be utilized to establish a closed-loop feedback process control of the process being performed on the processing station 100. For example, the pressure exerted by the contact element 134 may be continually adjusted/controlled by the controller in response to a measured metric indicative of process performance, for example, an amount of conductive material removed from a substrate in a polishing operation.

It is contemplated that alternative means for controlling the force exerted by the contact element 134 against the substrate 120 may equally be used, with or without use of the membrane 904, such as, for example, utilizing at least one of a fluid actuator, a linear actuator, a stepper or other motor, one or more springs, a lead or ball screw or a cam, or any other mechanism for incrementally adjusting the height or position of the contact element 134 and/or controlling the pressure exerted by the contact element 134 against the substrate 120. It is also contemplated that the contact pressure controller may alternatively move the upper layer 212 with respect to the contact element 134 in a similar manner.

It is further contemplated that the inflatable membrane 904, or other actuating means, is appropriately designed for the size, shape, and configuration of the contact elements 134 disposed in the pad assembly 106. For example, multiple contact pressure controllers 900 may be utilized where multiple contact elements 134 are disposed in the pad assembly 106 and should have an appropriate shape to accurately control the position and pressure applied by the contact element 134 against the substrate 120. The multiple contact pressure controllers 900 may be controlled collectively or independently. In addition, multiple contact pressure controllers 900 may be utilized to control the position and/or pressure exerted by any single one of a plurality of contact elements 134.

The pressure controller 900 also enables controlling the position of the upper surface of the contact element 134 with respect to the non-conductive surface 202 of the pad assembly 106. In addition to the pressure control advantages discussed above, this feature has the further advantage of allowing independent conditioning of the conductive surface 204 and the non-conductive surface 202 of the processing surface 104 of the pad assembly 106. For example, the contact element 134 may be retracted below the plane of the non-conductive surface 202 to facilitate conditioning of the non-conductive surface 202 of the pad assembly 106 without contacting the conductive surface 204 of the contact element 134 by a conditioner 1302 as depicted in FIG. 13.

It is further contemplated that actuators/pressure controllers (not shown), similar to the contact pressure controller 900 described above, may be utilized in place of, or in addition to, the contact pressure controller 900 to actuate and control the position of the non-conductive surface 202 of the pad assembly 106 relative to the conductive surface 204 of the pad assembly 106.

FIG. 10 depicts a partial sectional view of another embodiment of a contact element 1034 and contact pressure controller 1090. In this embodiment, the contact element 1034 includes a conductive layer 1012 coupled to a contact support plate 1014. The contact element 1034 is disposed in an aperture 1018 formed in a platen assembly 1042 that aligns with an aperture 220 formed in the processing pad assembly 106. The contact pressure controller 1090 includes a plenum defined in a body 1002 having a central recess 1004 disposed in the aperture 1018 below the contact element 134. The body 1002 is coupled to, or may be part of, the platen assembly 1042. A membrane 1010 disposed over a perforated plate 1006 is coupled to the body 1002, thereby sealing the plenum formed in the central recess 1004.

The central recess 1004 of the body 1002 is coupled to a fluid supply 902 which controllably provides a fluid, such as compressed air, to selectively inflate or deflate the membrane 1010 by adjusting the pressure within the central recess 1004 of the body 1002. As the membrane 1010 inflates or deflates, it presses upwards on the contact support plate 1014 of the contact element 1034, thereby causing the contact element 1034 to move upward or downward within the apertures 1018, 220. As the contact element 1034 moves up and down, a conductive surface 1016 of the conductive layer 1012 can apply a controllable force against a surface of the substrate 120 being polished or processed.

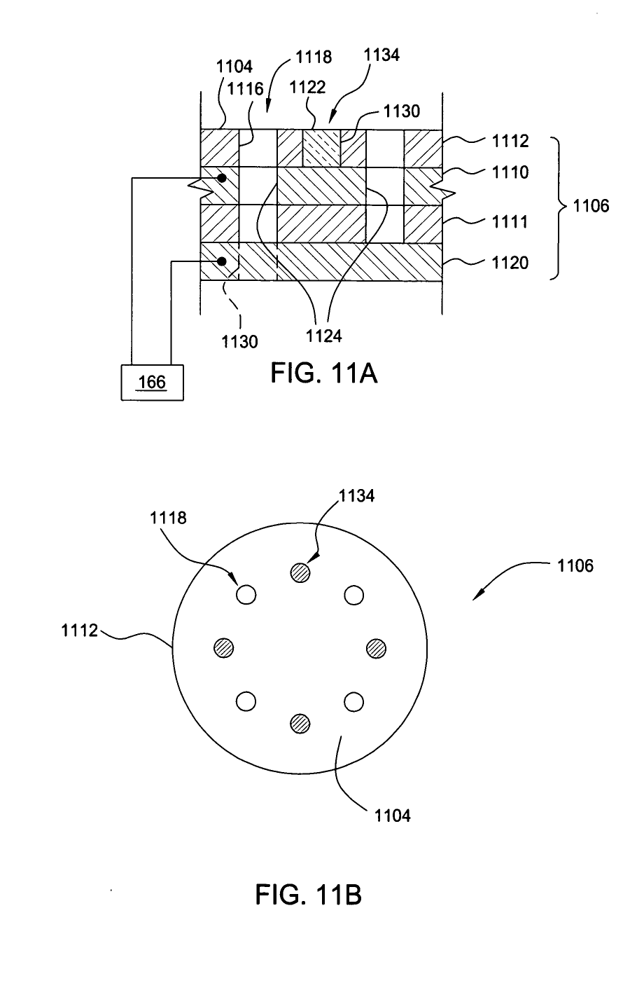

FIGS. 11A and 11B respectively depict partial side and top views of another embodiment of a pad assembly 1106. The pad assembly 1106 includes an electrode 1120, an optional subpad 1111 and an upper non-conductive layer 1112 respectively, similar to the electrode 210, the subpad 211 and the upper, non-conductive processing layer 212 as described above. A conductive layer 1110 is interposed between the optional subpad 1111 and the upper layer 1112. The conductive layer 1110 may comprise copper or any other conductive material compatible with process conditions and chemistries. For example, other suitable materials may include, but are not limited to, gold, cobalt, platinum, nickel, copper, tin, graphite, carbon black, carbon nanotubes or other conductive fillers disposed in a polymer matrix such as acrylic polymers, nylon, epoxy, polysilicone or polyurethane, and the like. In addition, the conductive layer 1110 may comprise any of the materials described above as suitable for contact elements or other conductive layers of pad assemblies. Further examples of materials and configurations suitable for use as a conductive layer are also described in U.S. patent application Ser. No 10/727,724, filed Dec. 3, 2003, which is hereby incorporated by reference in its entirety.

A plurality of permeable passages 1118 are formed through the upper layer 1112, conductive layer 1110 and subpad 1111 to fluidly couple the upper surface 1104 of the processing pad 1106 with the electrode 1120. In the embodiment depicted in FIGS. 11A-B, the plurality of passages 1118 are a plurality of perforations 1116 formed through the processing pad assembly 1106. Optionally, an insulator may be provided on at least a portion of an inner wall 1124 of the passages 1118 to prevent current from flowing directly between the conductive layer 1110 and the electrode 1120 through the passages 1118.

Optionally, an extension 1130 of at least one of the passages 1118 may be formed to couple the pad assembly 1106 to an electrolyte supply, for example, through the platen assembly 142 as shown in FIGS. 1 and 2. Alternatively, electrolyte may be provided during operation to the top of the pad assembly 1106 from the electrolyte supply 170 through a conduit or pipe (not shown).

The pad assembly 1106 also includes a plurality of contact elements 1134 formed on the surface 1104 of the upper layer 1112. The contact elements 1134 may be of any size or shape and distributed in any geometric pattern, or randomly, across the upper surface 104 of the processing pad 212 to provide optimum electrical contact and polishing performance. In one embodiment, the plurality of contact elements 1134 are formed by a plug of conductive material 1122 disposed in an aperture 1130 formed through the processing layer 212. The conductive material 1122 fills the aperture 1130 and is in contact with the conductive layer 1110. Examples of suitable conductive materials 1122 include particles of tin, copper, nickel, gold, platinum, palladium, and the like disposed in a polymer matrix. Alternatively, other conductive materials include metals, graphite, and other conductive materials compatible with process conditions and chemistries. It is also contemplated that the material 1122 may be selected from material suitable for fabrication of the contact elements 134 and the conductive layer 1110, as described above.

In operation, the conductive layer 1110 and the electrode 210 are coupled to opposing terminals of the power supply 166. When a substrate is being processed, electrolyte is delivered to the pad assembly 1106 via a pipe disposed above the pad assembly 1106 or through the pad assembly 1106 via the extension 1130 of the passage 1118. The substrate is placed into contact with the processing surface 1104 of the pad assembly 1106, and thereby into contact with the contact element 1134. The substrate is thus biased via contact with the contact element 1134. The electrolyte fills the plurality of passages 1118 and completes the circuit between the biased substrate and the electrode 1120, thereby facilitating electrolytic dissolution or deposition, depending on the polarity of the connections from the power supply 166.

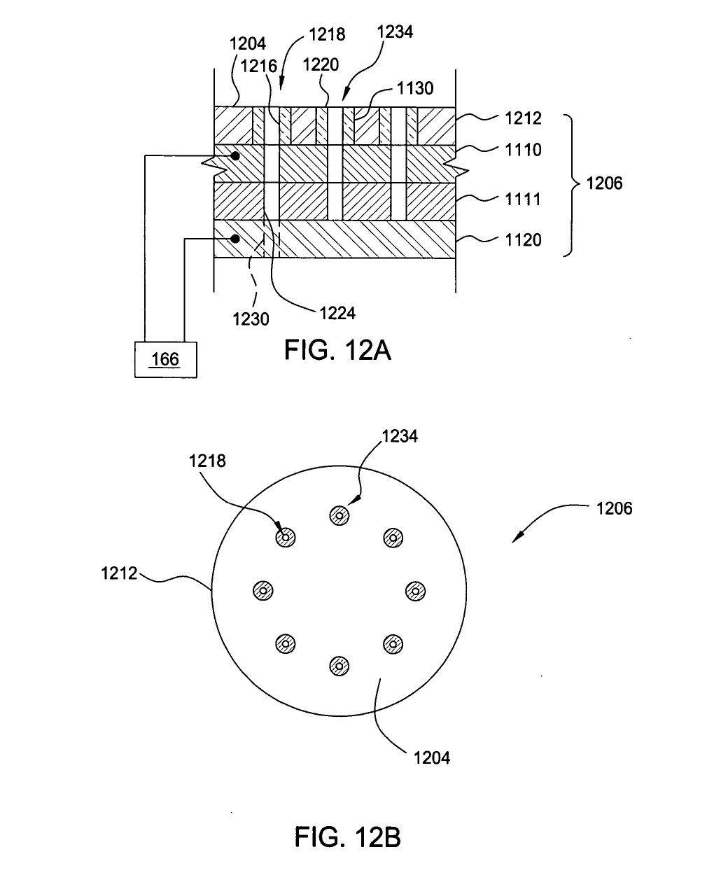

FIGS. 12A and 12B respectively depict partial sectional and top views of another embodiment of a pad assembly 1206. The pad assembly 1206 is substantially similar to the pad assembly 1106 described above, except as follows. In the embodiment depicted in FIGS. 12A-B, the plurality of permeable passages 1118 comprise a plurality of perforations 1216 formed through one or more of the contact elements 1234. In the embodiment depicted in FIG. 12, a single perforation 1216 is formed through the center of each conductive region 1220 such that the conductive material 1122 forming the region 1220 surrounds the perforation 1216. It is contemplated that the perforations 1216 may also be formed outside of the contact elements 1234 or that multiple perforations 1216 may be formed through one or more of the contact elements 1234. An insulator may optionally be provided on at least a portion of an inner wall 1224 of the perforations 1216 to prevent current from flowing directly between the conductive layer 1110 and the electrode 1120 through the perforations 1216. Optionally, an extension 1230 of at least one of the passages 1218 may be formed to coupled the pad assembly 1206 to an electrolyte supply as described with respect to the embodiments disclosed above.

One exemplary method for manufacturing a pad assembly (described with reference to FIG. 11A) includes first forming the plurality of apertures 1130 in the upper layer 1112. The upper layer is then adhered to the underlying conductive layer 1110. The plurality of apertures 1130 are then filled with a conductive material. In one example, the apertures 1130 may be filled by depositing a conductive material disposed in an uncured polymer over the surface 1104 of the upper pad 1112, thereby filling the plurality of apertures 1130. The conductive material 1122 is then cured by evaporating a solvent from the polymer. Excess conductive material 1122 on top of the upper pad 1112 may be removed, for example, by mechanical polishing, leaving the conductive material 1122 disposed solely in the apertures 1130, as depicted in FIG. 11.

Next, a plurality of apertures 1116 may be formed through the upper layer 1112 and conductive layer 1110 in a predefined location and pattern. For example, the embodiment depicted in FIG. 1 1A may be fabricated by forming the apertures 1116 outside of the contact elements 1134. The embodiment depicted in FIG. 12A may be fabricated by forming the apertures 1218 through the contact elements 1234. In embodiments where the subpad 1111 is present, the apertures 1116, 1218 are formed through the subpad 1111 as well. The electrode 1120 is then coupled to the subpad 1111, for example, by adhesives. At least one hole (depicted as extension 1130 in FIG. 11A and extension 1230 in FIG. 12A) may optionally be formed in the electrode 1120 to allow electrolyte to flow from the supply to the surface 1104, 1204 of the pad assemblies 1106, 1206. This last step may be omitted in embodiments where the electrode 1120 is disposed on the platen assembly 142 rather than as part of the processing pad assembly.

Another exemplary method for manufacturing a pad assembly (described with reference to FIG. 11A) includes first forming the plurality of apertures 1130 in the upper layer 1112. Next a protrusion, i.e., a plug of conductive material 1122, is formed on the surface of the conductive layer 1110. In one embodiment, the conductive layer 1110 comprises conductive material disposed in a polymer and the plugs of conductive material 1122 are formed by pressing the conductive layer 1110 against a suitable mold to form the plugs from the material 1122 directly on the surface of the conductive layer 1110. The upper layer 1112 is then adhered to the underlying conductive layer 1110. The plurality of apertures 1130 are filled with the plugs of conductive material 1122 extending from the conductive layer 1110. Optionally, excess conductive material 1122, if any, extending above the processing surface 104 of the upper layer 1112 may be removed, for example, by mechanical polishing, leaving the conductive material 1122 disposed solely in the apertures 1130, as depicted in FIG. 11A.

Next, a plurality of apertures 1116 may be formed through the upper layer 1112 and conductive layer 1110 in a predefined location and pattern. For example, the embodiment depicted in FIG. 11A may be obtained by forming the apertures 1116 outside of the contact elements 1134. The embodiment depicted in FIG. 12A may be obtained by forming the apertures through the contact elements 1134. In embodiments where the subpad 1111 is present, the apertures 1116 are formed through the subpad 211 as well. The electrode 1120 is then adhered to the subpad 1111. Alternatively, the electrode 1120 may be disposed on the platen assembly 142 rather than as part of the processing pad assembly. At least one hole (depicted as extension 1130 in FIG. 11A and extension 1230 in FIG. 12A) may optionally be formed in the electrode 1120 to allow coupling to an electrolyte supply.

Thus, various embodiments of a pad assembly and processing system suitable for electrochemical processing of substrates have been provided. The pad assemblies provide good compliance to the substrate's surface to promote uniform electrical contact that enhances processing performance. Moreover, the pad assemblies are configured to minimize scratching while processing, advantageously reducing defect generation and thereby lowering the unit cost of processing.

While the foregoing is directed to the illustrative embodiment of the present invention, other and further embodiments of the invention may be devised without departing from the basic scope thereof, and the scope thereof is determined by the claims that follow.

1. A pad assembly for processing a substrate, comprising:
a body having a non-conductive first surface and an opposing second surface;
a conductive element having a planar conductive first surface laterally disposed from the non-conductive first surface and defining a top processing surface therewith;
an electrode coupled to the second surface of the body; and
a first set of holes formed through the processing surface and exposing the electrode to the processing surface.

2. The pad assembly of claim 1, wherein the conductive first surface is concentric with the non-conductive first surface.

3. The pad assembly of claim 2, wherein the conductive first surface has an outer diameter of about 2 inches to about 16 inches.

4. The pad assembly of claim 1, further comprising, a second set of holes formed through the non-conductive first surface and the electrode.

5. The pad assembly of claim 1, further comprising a subpad disposed between the body and the electrode.

6. The pad assembly of claim 5, wherein the subpad has a hardness of less than about 20 on the Shore A scale.

7. The pad assembly of claim 5, wherein the subpad has a hardness of less than about 5 on the Shore A scale.

8. The pad assembly of claim 5, wherein the subpad has a compressibility of about 25% in a range of about 1-9 pounds per square inch at a 0.2 inch per minute strain rate.

9. The pad assembly of claim 1, wherein the conductive first surface extends beyond a plane defined by the non-conductive first surface.

10. The pad assembly of claim 1, wherein the conductive element is biased in a direction normal to the first non-conductive surface.

11. The pad assembly of claim 1, wherein the conductive element further comprises a conductive material disposed in a binder.

12. The pad assembly of claim 1, wherein the conductive element further comprises a metal or metal alloy disposed in a binder.

13. The pad assembly of claim 1, wherein the conductive element further comprises copper particles disposed in a polymer matrix.

14. The pad assembly of claim 1, wherein the conductive element further comprises nickel particles disposed in a polymer matrix.

15. The pad assembly of claim 1, wherein the conductive element further comprises tin particles disposed in a polymer matrix.

16. The pad assembly of claim 1, wherein the conductive element further comprises a fabric coated with conductive material.

17. The pad assembly of claim 16, further comprising a conductive layer disposed on the coated fabric.

18. The pad assembly of claim 1, wherein the conductive first surface further comprises at least one aperture formed therethrough.

19. The pad assembly of claim 1, wherein the conductive first surface is embossed.

20. The pad assembly of claim 1, wherein the conductive first surface is textured.

21. The pad assembly of claim 1, wherein the conductive element is disposed in a center of the processing pad assembly.

22. The pad assembly of claim 21, wherein the conductive element further comprises at least one aperture formed therethrough coaxial with the center of the pad assembly.

23. The pad assembly of claim 1, further comprising at least one passage formed through at least one of the body or the conductive element, the passage adapted to allow an electrolyte to flow therethrough.

24. The pad assembly of claim 1, wherein the conductive element further comprises a plurality of conductive elements laterally separated by the body.

25. The pad assembly of claim 1, further comprising an insulator disposed beneath the conductive element opposite the conductive first surface.

26. The pad assembly of claim 25, wherein the insulator further comprises an upper layer and a lower layer.

27. The pad assembly of claim 26, wherein the upper layer is harder than the lower layer.

28. The pad assembly of claim 26, further comprising:
a subpad disposed between the body and the electrode, wherein the lower layer is softer than the subpad.

29. The pad assembly of claim 1, wherein the conductive element comprises an annulus.

30. The pad assembly of claim 1, wherein the conductive element comprises an annulus formed about a periphery of the top processing surface.

31. The pad assembly of claim 1, further comprising:
a plurality of conducive elements.

32. The pad assembly of claim 31, wherein the plurality of conductive elements are concentrically disposed with respect to each other.

33. A system for processing a substrate, comprising:
a platen;
a body disposed on the platen and having a dielectric surface;
at least one conductive contact pad having a conductive surface defining a processing surface with the dielectric surface; and
an electrode disposed between the platen and the body.

34. The system of claim 33, wherein the contact pad is coupled to the platen.

35. The system of claim 33, wherein the contact pad is coupled to the body, the contact pad and the body comprising a replaceable pad assembly.

36. The system of claim 33, wherein the contact pad is concentric with the body.

37. The system of claim 36, wherein the contact pad has an outer diameter of about 2 inches to about 16 inches.

38. The system of claim 36, wherein the contact pad has a ring shape.

39. The system of claim 33, wherein the contact pad further comprises a plurality of contact pads having a conductive surface defining a processing surface with the dielectric surface.

40. The system of claim 33, further comprising at least one passage formed through at least one of the body or the conductive pad, the passage adapted to allow an electrolyte to flow therethrough.

41. The system of claim 33, wherein the conductive surface of the contact pad and the dielectric surface of the body are movable with respect to each other.

42. The system of claim 41, further comprising:
an actuator disposed beneath the conductive surface and adapted to control a relative elevation of the conductive and the dielectric surfaces.

43. The system of claim 42, wherein the actuator further comprises:
an inflatable membrane.

44. The system of claim 43, wherein the actuator further comprises:
a plenum disposed beneath the inflatable membrane and adapted to be coupled to a fluid supply.

45. The system of claim 42, wherein the actuator further comprises:
at least one of a fluid actuator, linear actuator, a stepper or other motor, one or more springs, a lead or ball screw or a cam.

46. The system of claim 42, wherein the actuator is adapted to selectively control the position of the conductive surface between a first position below the dielectric surface and a second position above the dielectric surface.

47. The system of claim 42, wherein the actuator is adapted to selectively control pressure exerted by the conductive surface against the substrate during processing.

48. The system of claim 42, further comprising:
an actuator disposed beneath the dielectric surface and adapted to control the elevation thereof.

49. The system of claim 33, wherein the contact pad further comprises a conductive material disposed in a binder.

50. The system of claim 33, wherein the contact pad further comprises a metal or metal alloy disposed in a binder.

51. The system of claim 33, wherein the contact pad further comprises tin particles disposed in a polymer matrix.

52. The system of claim 33, wherein the contact pad further comprises copper particles disposed in a polymer matrix.

53. The system of claim 33, wherein the contact pad further comprises nickel particles disposed in a polymer matrix.

54. The system of claim 33, wherein the contact pad further comprises a fabric coated with conductive material.

55. The system of claim 54, further comprising a conductive layer disposed on the coated fabric.

56. The system of claim 33, further comprising a subpad coupled to a lower surface of the body.

57. The pad assembly of claim 56, wherein the subpad has a hardness of less than about 20 on the Shore A scale.

58. The pad assembly of claim 56, wherein the subpad has a hardness of less than about 5 on the Shore A scale.

59. The pad assembly of claim 56, wherein the subpad has a compressibility of about 25% in a range of about 1-9 pounds per square inch at a 0.2 inch per minute strain rate.

60. A pad assembly, comprising:
an upper layer having a processing surface having conductive and non-conductive regions formed therein;
a first conductive layer disposed beneath the upper layer and in electrical contact with the conductive regions of the upper layer;
a dielectric sub-layer disposed beneath the first conductive layer;
a second conductive layer disposed beneath the sub-layer; and
a plurality of holes formed through the upper layer, first conductive layer, and the sub-layer to at least an upper surface of the second conductive layer.

61. The pad assembly of claim 60, wherein the first conductive layer comprises copper.

62. The pad assembly of claim 60, wherein the conductive regions of the upper layer comprises a conductive polymer.

63. The pad assembly of claim 60, wherein the conductive regions of the upper layer comprises tin particles disposed in a polymer matrix.

64. The pad assembly of claim 60, wherein the conductive regions of the upper layer comprises copper particles disposed in a polymer matrix.

65. The pad assembly of claim 60, wherein the conductive regions of the upper layer comprises nickel particles disposed in a polymer matrix.

66. The pad assembly of claim 60, wherein the holes are formed at least through the non-conductive regions of the upper layer.

67. The pad assembly of claim 60, wherein the holes are formed at least through the conductive regions of the upper layer.

68. The pad assembly of claim 60, wherein the subpad has a hardness of less than about 20 on the Shore A scale.

69. The pad assembly of claim 60, wherein the subpad has a hardness of less than about 5 on the Shore A scale.

70. The pad assembly of claim 60, wherein the subpad has a compressibility of about 25% in a range of about 1-9 pounds per square inch at a 0.2 inch per minute strain rate.

71. A pad assembly for electrochemical processing of a substrate, comprising:
a body having a processing surface, the processing surface having a conductive processing region and a non-conductive processing region;
an electrode coupled to the body; and
a plurality of apertures extending through the conductive processing region of the body and fluidly coupling the electrode to the conductive processing region through the body.

72. The pad assembly of claim 71, further comprising
a conductive layer disposed in the body and coupled to each of the conductive processing regions.

73. A method of forming a processing pad assembly, comprising:
forming a plurality of holes through a non-conductive processing pad having a first surface and an opposing second surface;
adhering a first conductive layer to the second surface of the processing pad; and
filling the plurality of holes with a conductive material.

74. The method of claim 73, wherein a processing surface is defined by the first surface of the non-conductive processing pad and a first surface of the conductive material.

75. The method of claim 73, wherein the conductive material comprises a conductive material disposed in a polymer matrix.

76. The method of claim 73, wherein the conductive material comprises at least one of tin, copper, nickel, gold, platinum, or palladium particles in a polymer matrix.

77. The method of claim 73, wherein the step of filling the plurality of holes further comprises:
depositing conductive materials dispersed in an uncured polymer into the holes; and
curing the polymer to form a solid mass of conductive materials dispersed in the polymer.

78. The method of claim 77, further comprising:
planarizing the first surface of the of the processing pad to remove any excess cured polymer.

79. The method of claim 73, further comprising:
adhering a sub-pad to a bottom surface of the first conductive layer; and
forming a plurality of holes through the non-conductive processing pad and extending through the first conductive layer and the sub-pad.

80. The method of claim 79, further comprising:
adhering a second conductive layer to a bottom surface of the sub-pad.

81. The method of claim 73, wherein the first conductive layer comprises copper.

82. A method of forming a processing pad assembly, comprising:
forming a plurality of holes through a non-conductive processing pad having a first surface and an opposing second surface;
forming a plurality of protrusions on a first conductive layer; and
adhering the first conductive layer to the second surface of the processing pad, the protrusions extending through the holes.

83. The method of claim 82, wherein a processing surface is defined by the first surface of the non-conductive processing pad and a first surface of the conductive material.

84. The method of claim 82, wherein the conductive material comprises a conductive material disposed in a polymer matrix.

85. The method of claim 82, wherein the conductive material comprises at least one of tin, copper, nickel, gold, platinum, or palladium particles in a polymer matrix.

86. The method of claim 82, further comprising:
adhering a sub-pad to a bottom surface of the first conductive layer; and
forming a plurality of holes through the non-conductive processing pad and extending through the first conductive layer and the sub-pad.

87. The method of claim 86, further comprising:
adhering a second conductive layer to a bottom surface of the sub-pad.
